(19) United States
(12) Patent Application Publication
(10) Pub. No.: US 2013/0127174 A1
(43) Pub. Date: May 23, 2013

(54) Method for Generating Tidal Energy Utilizing the Scalar Gravitational Potential of Celestial Bodies

(71) Applicant: Duncan G. Cumming, Rancho Palos Verdes, CA (US)

(72) Inventor: Duncan G. Cumming, Rancho Palos Verdes, CA (US)

(21) Appl. No.: 13/741,558

(22) Filed: Jan. 15, 2013

(51) Int. Cl. H02K 7/18; F01D 1/00; H02P 9/00

(52) U.S. Cl. CPC H02K 7/18; H02P 9/008; F01D 1/00
USPC 290/1 A; 290/7; 60/527

(57) ABSTRACT

Tidal energy generator uses the scalar gravitational potential to utilize energy from celestial bodies. Kinetic energy is extracted from the celestial objects by means of a system including a rotatable arm, a mass fluctuation producing system arranged on the arm and including dielectric material whose mass fluctuates when subjected to a changing electromagnetic field in view of the scalar gravitational potential of the celestial objects, a rotation system that rotates the arm at a variable speed to cause rotation of the mass fluctuation producing system thereon, and a control system that controls the mass fluctuation producing system and rotation system in order to accelerate the dielectric material when it has a relatively light mass and decelerate the dielectric material when it has a relatively heavy mass. Excess energy arising from an energy differential between the acceleration and deceleration of the dielectric material is directed to a load.

### FIELD OF THE INVENTION

The present invention relates generally to methods for generating tidal energy utilizing the scalar gravitational potential of the moon and other celestial bodies. More specifically, the present invention relates to methods for harnessing gravitational interaction with the moon and other celestial objects so that the kinetic energy of such objects could be used as a power source, for example, for generating electrical power.

### BACKGROUND OF THE INVENTION

Mankind has sought for a long time a practical energy power to use that would be relatively free and ideally also unlimited in supply. Humans have successfully harnessed the wind, hydroelectric power, and even the ocean tides in an elementary manner. Until now, however, harnessing ocean tides has been on a very limited, experimental scale not suitable for any substantial energy production on a commercial scale, because it is not believed that a practical commercial machine has been developed yet.

One complication to achieve this objective is that all energy from tidal forces must ultimately come from the kinetic energy of the moon, which is a finite and limited resource. Furthermore, there are only a few sites where even this limited resource, i.e., the kinetic energy of the moon, can be harvested in the form of tidal energy. This is because the gravitational attraction from the moon must first interact with the oceans, and then the movement of the oceans must in turn be used to generate tidal energy.

A conventional tidal energy plant is based on the gravitational attraction between the earth and the moon, given by the equation:

$$F = G \frac{{m}_{1} {m}_{2}}{{d}^{2}} \qquad ( 1 )$$

Where G is the Newtonian constant of gravitation, m₁ the mass of the oceans of the Earth, m₂ the mass of the moon and d the earth-moon distance. Since the force decreases with the square of the distance, forces from celestial objects other than the moon are negligible compared to the force from the moon itself, so that a conventional tidal energy plant would necessarily derive the vast majority of its energy from the moon.

The term “tidal energy” is used herein in a slightly broader sense than it is used for a conventional tidal energy generator. The term herein refers to energy extracted from any celestial body by any form of gravitational interaction. It is not limited only to the moon, and it is not limited only to Newtonian gravitational attraction as described above. For example, a “gravitational slingshot” is a technique for accelerating a spacecraft whereby the spacecraft flies by and passes in close proximity to another planet, and gains considerable kinetic energy in the process. The planet loses an equivalent amount of kinetic energy, and the spacecraft is accelerated towards its eventual destination. Many robotic interplanetary missions have used this method, which would be a form of “tidal energy” as the term is used herein. The energy of the spacecraft is extracted from the planet during the planetary flyby, by the method of gravitational interaction.

It is disclosed in U.S. Pat. No. 5,280,864 (hereinafter the “Woodward patent”), amongst several others, that there is a second gravitational parameter responsible not for gravitational attraction per se but rather for gravitational induction of inertia. This parameter is called the scalar gravitational potential Φ, given by:

$$Φ = G {\int }_{V} ( ρ / r ) \partial V \qquad ( 2 )$$

where ρ is the matter density at the distance r from the field point and the integration extends over all space. The scalar gravitational potential has units of energy per unit mass, e.g., J/kg in the MKS system. The absolute value of scalar gravitational potential at the Earth's surface with respect to the Milky Way is about ≧130 GJ/kg. In other words, a mass of 1 kg would need an energy of at least about 130 GJ to leave the gravity field of the Milky Way.

Since contributions to the scalar gravitational potential Φ by matter decrease as 1/r with increasing distance, but the amount of matter in a spherical shell at a distance r increases as r², the dominant contributions to the scalar gravitational potential Φ are from celestial objects other than the moon, although the moon itself also makes a minor contribution. This situation is illustrated in FIG. 1. A spherical shell 89 of radius r and thickness δr contains a volume given by

A=4πr²δr

Assuming that the density of celestial objects in space is approximately constant, the amount of mass enclosed within this shell is proportional to r². If the radius is doubled to 2r, shown as shell 90, then the amount of mass enclosed by the shell is multiplied by four. On the other hand, the contribution to the scalar gravitational potential Φ from each particle of matter enclosed within the shell 90 is halved, because the contribution varies as 1/r and r has been doubled. Consequently, the total contribution to the scalar gravitational potential Φ from shell 90 is double the contribution from shell 89.

The moon is the closest celestial object to Earth, so it produces the largest contribution to the scalar gravitational potential Φ of any single such object. Other celestial objects each produce a smaller contribution to the scalar gravitational potential Φ than the moon, but they are a lot more numerous. Consequently, the total contribution to the scalar gravitational potential Φ from the other celestial objects greatly exceeds that from the moon, even though the contribution from any one particular celestial object is less than that from the moon. This is in contrast to the force of gravitational attraction F, where the largest contribution comes from the moon and the other celestial objects contribute very little additional force. Hence a lot more tidal energy is available by utilizing the scalar gravitational potential Φ than by using the force of Newtonian gravitational attraction F, as in a conventional tidal energy system

In the Woodward patent, it is explained that the condition imposed by the gravitational induction of inertia is

$$\frac{{Φ}_{c}}{{c}^{2}} \approx 1 \qquad ( 3 )$$

where Φ_{c} is the scalar gravitational potential of all of the celestial objects combined. Employing the well-known relationship E=mc² in the form ρ=E/c², where E is the local energy density, the Woodward patent contains a derivation for an equation for the local rest mass density

$$ρ = ( \frac{1}{4 π G {ρ}_{0} {c}^{2}} ) \frac{{\partial }^{2} E}{\partial {t}^{2}} + {ρ}_{0} \qquad ( 4 )$$

From this equation, it can be seen that time-varying energy densities in material media lead to fluctuations in density of this material media.

Additional prior art of interest includes U.S. Pat. Nos. 3,668,412 (Vrana et al.), 6,098,924 (Woodward), 6,347,766 (Woodward), 6,745,980 (Neff), 7,832,297 (Hewatt), 7,900,874 (Fiala), and 8,066,226 (Fiala) and U.S. Pat. Appln. Publ. No. 2007/0295010 (Stephens). All of this prior art is incorporated by reference herein. Further, background information for understanding the invention may be obtained from Fearn, H. and Woodward, J. F. “Recent Results of an Investigation of Mach Effect Thrusters”, American Institute of Aeronautics and Astronautics, 2012, March, P. and Palfreyman, A. “The Woodward Effect: Math Modeling and Continued Experimental Verifications at 2 to 4 MHz”, Space Technology and Applications International Forum—STAIF 2006, edited by M. S. El-Genk© 2006 American Institute of Physics 0-7354-0305-8/06 pages 1321-1332, and Mahood, T. L. “A Torsion Pendulum Investigation of Transient Machian Effects”, California State University—Fullerton (CSUF) Masters Thesis, 1999. This literature is also incorporated by reference herein.

In consideration of the scientific principles identified in the Woodward patent, among others, it would be beneficial to provide a more direct method of harnessing gravitational interaction with not only the moon, but also with other celestial bodies so that a very large amount of energy is available, without any concerns about depletion of resources. The amount of energy available from all of the celestial objects together is, in fact, sufficient to satisfy any foreseeable needs of mankind.

### OBJECTS AND SUMMARY OF THE INVENTION

Accordingly, it is an object of at least one embodiment of the present invention to provide a method for harnessing gravitational interaction with the moon and other celestial objects (hereinafter referred to as “celestial objects”) so that the kinetic energy of such objects could be used as a power source for, e.g., generating electrical power.

To achieve this object and others, a system and method of electrical power generation in accordance with the invention are based upon enhancing or reducing the inertial masses of material objects based upon equation (4) above, then using transient mass fluctuations for transfer of kinetic energy from celestial objects to a terrestrial electrical generator. The method for induction of mass fluctuations comprises configuring apparatus such that large transient positive or negative values of the δ²E/δt² term in equation (4) are produced. This may be done, for example, by the application of suitable electromagnetic fields.

A method for electrical power generation comprises structuring apparatus so as to accelerate the mass while it is lighter, then decelerate the mass when it is heavier. More kinetic energy is expected to be extracted from the deceleration of the heavier mass than is used for the acceleration of the lighter mass.

Conservation of energy shows that the celestial objects lose an equivalent amount of kinetic energy. Advantages are realized in comparison to a conventional tidal energy generator, where gravitational attraction F is used in place of scalar gravitational potential Φ. In this case, the kinetic energy lost by the moon is equal to the useful electrical energy extracted from the generator.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 illustrates two shells containing celestial objects, used to generate mass fluctuations in accordance with the invention.

FIG. 2 is a cross sectional view of a prior art vacuum capacitor, used here to generate transient mass fluctuations.

FIG. 3a is a cross sectional view of a more generalized capacitor used to generate transient mass fluctuations.

FIG. 3b illustrates the use of a magnetic field, rather than electric field, to generate transient mass fluctuations.

FIG. 4 is a cross sectional view of a highly robust vacuum capacitor

FIG. 5 illustrates an electrical generation system using transient mass fluctuations in accordance with the invention.

FIG. 6 illustrates an alternative embodiment of the electrical generation system using multiple rotors in accordance with the invention.

FIG. 7 illustrates the waveforms present in the electrical generation system in accordance with the invention.

FIG. 8 illustrates the timing of the multiple rotor system in accordance with the invention.

FIG. 9 illustrates the capacitor drive waveform used to create transient mass fluctuations.

FIG. 10a illustrates an embodiment of the invention using variable field current generators.

FIG. 10b illustrates an alternative embodiment of the invention using fixed field current generators in accordance with the invention.

FIG. 11 illustrates use of transient mass fluctuations for the production of thrust in accordance with the invention.

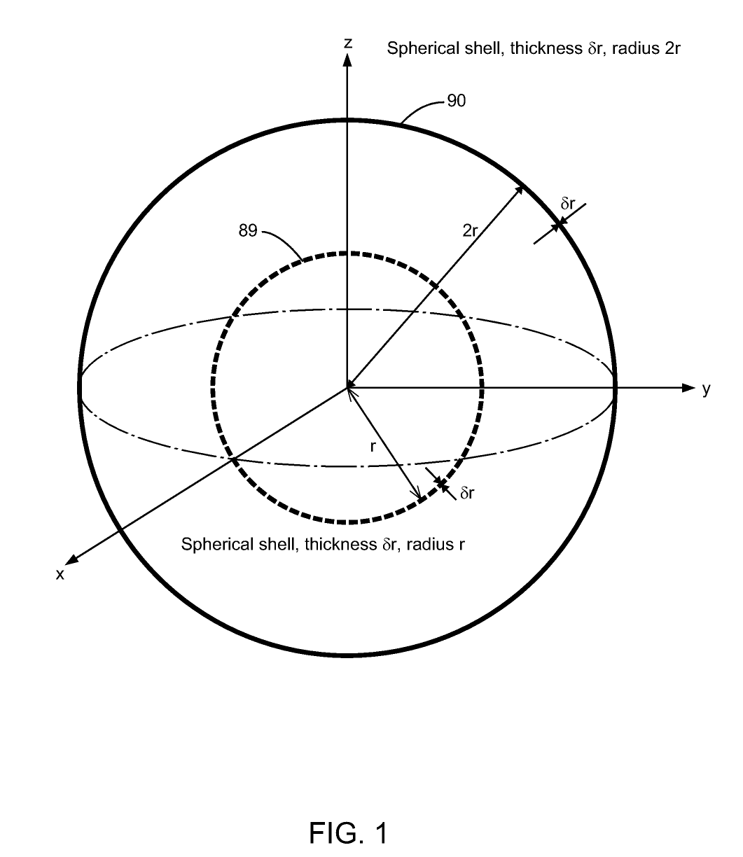

### DETAILED DESCRIPTION OF THE INVENTION

In principle, there are many ways to produce large, rapidly varying energy densities, where the inertial reaction mass fluctuation effect upon which this method is based is generated. Unless otherwise indicated, all such ways are contemplated to be within the scope and spirit of the invention. Of all of the possible ways available, one specific method expected to have the most advantages from the point of view of ease of generation and control is the application of rapidly varying electromagnetic fields, in circuits of straight-forward design, to material core elements of capacitive and/or inductive components. An example of the method described here employs alternating electromagnetic fields to produce useful effects.

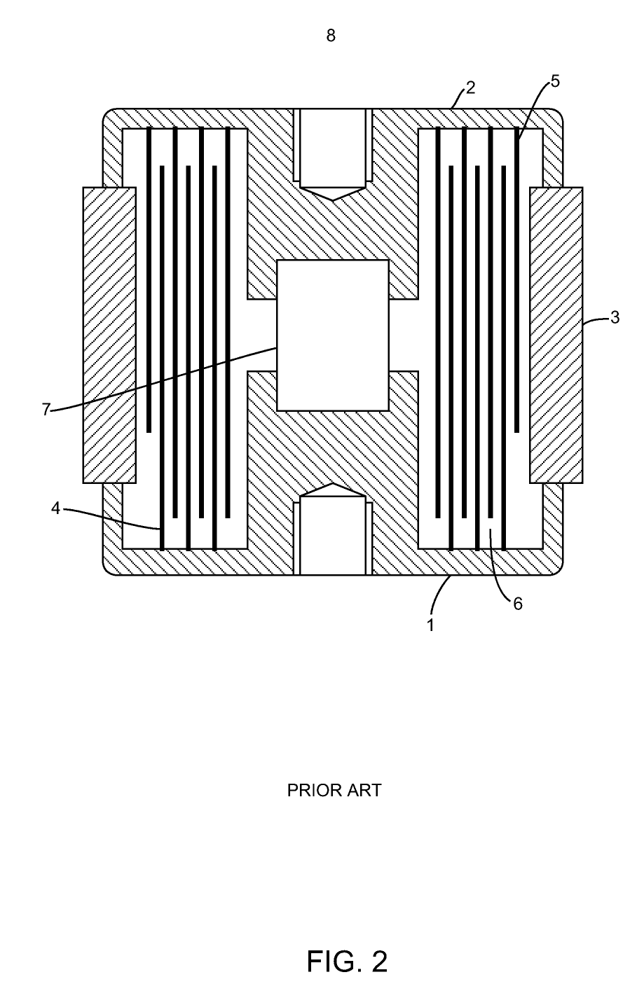

Referring first to FIG. 2 to provide background, a variable mass device is shown schematically in FIG. 2. The variable mass device comprises a high voltage capacitor preferably with a vacuum dielectric that can be driven to voltages of a few tens of kilovolts at frequencies of a few hertz without appreciable losses. (Such capacitors are available at Jennings Technology of San Jose, Calif.). The variable mass device comprises copper end plates 1 and 2, a ceramic insulator 3 vacuum brazed to the end plates 1, 2, and copper cylinders 4, 5 that comprise the plates of the capacitor 8. A vacuum 6 comprises the fluctuating mass. This is maintained, for example, at a level of approximately 10⁻⁷ Torr. A ceramic spacer 7 maintains an exact spacing between the copper cylinders 4 and 5.

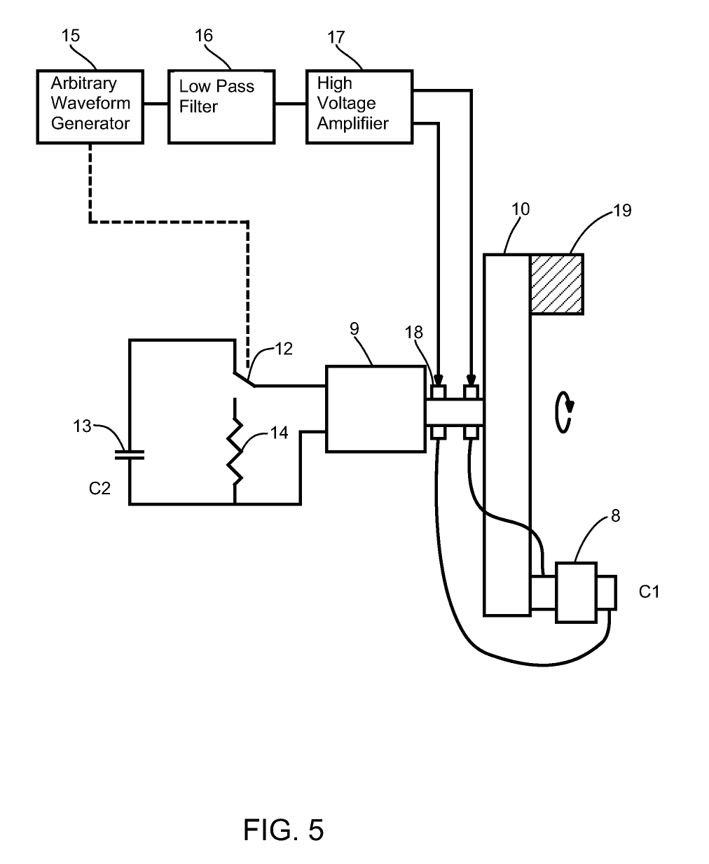

The vacuum capacitor 8 is driven by an arbitrary waveform generator, via a low pass filter, and a suitable high voltage amplifier, as shown in FIG. 5 (described below). The sampling rate is preferably much higher than the filter frequency, and a high resolution arbitrary waveform generator, preferably 16 bit, is optimally used. This prevents step waveforms from being transmitted to the capacitor 8, which may have deleterious results.

Estimating a range of mass fluctuation that can be achieved by such a device, involves the following calculations, the mass density fluctuation in C1 is given by Equation (4) above:

$$δρ ( t ) = ( \frac{1}{4 π G {ρ}_{0} {c}^{2}} ) \frac{{\partial }^{2} E}{\partial {t}^{2}} \qquad ( 5 )$$

δρ(t) integrated over the volume of the dielectric of capacitor 8 is a transient mass fluctuation δm(t) and δ²E/δt² is the time rate of change of the power applied to the capacitors 8, that is δP/δt. Preferably, one applies a periodic sawtooth waveform to the capacitor 8, with a period of about 6 Hz, an amplitude of about 20 kV, and a rise time to fall time ratio of about 10 to 1. The corners of the waveform are suitably rounded so as to avoid large transients of δ²E/δt², which reduce efficiency and can even cause damage to the capacitor 8. (The Woodward patent does not envision that the mass fluctuation δm exceeds the rest mass m, as is the case for this invention.) However, it has been experimentally observed that mass fluctuations for the vacuum capacitor 8 have a magnitude of a few percent when driven as described above, just as Woodward and others have observed mass fluctuations of the predicted amounts when δm does not exceed the rest mass m.

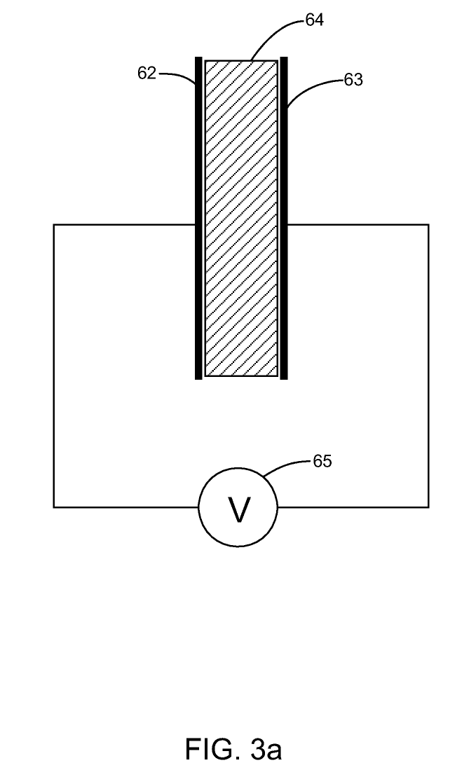

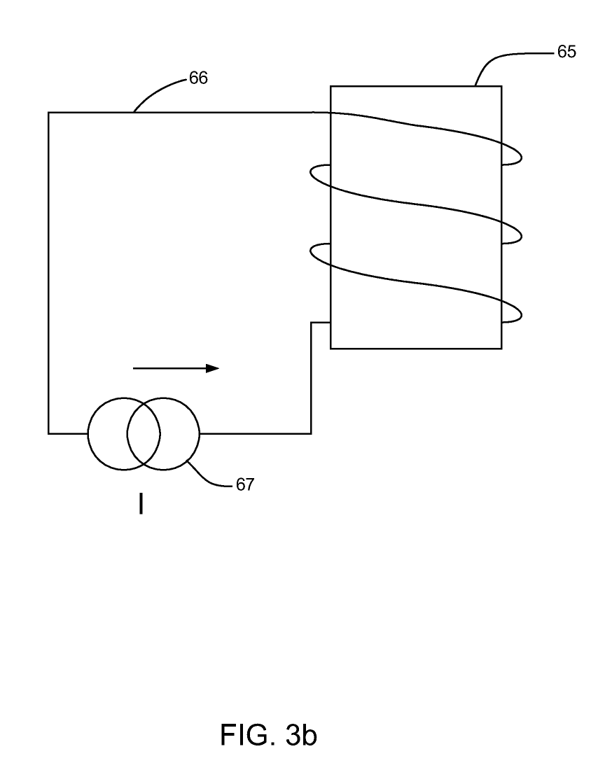

FIG. 3a is a more generalized representation of the vacuum capacitor 8 shown in FIG. 2. In its simplest form, this representation of vacuum capacitor 8 comprises two plates 62 and 63 enclosing a dielectric 64. A power supply 65 provides a fluctuating voltage to the plates 62, 63. Preferably, the dielectric 64 comprises what is commonly referred to as a vacuum, i.e., nitrogen gas at a pressure of about 10⁻⁷ torr. This has a very low mass density ρ₀, which is a desirable feature for this invention because ρ₀ appears in the denominator of equation (5), so that a lower mass density results in a higher mass fluctuation. By using a higher pressure, the mass can be increased. A higher pressure results in a more massive dielectric, but also reduces the voltage V that may be applied before arcing occurs between the plates 62, 63.

A method in accordance with the invention depends in part on the use of a controlled level of vacuum for the dielectric 64. Depending on the design of the capacitor, it may be advantageous to use gas pressures either higher or lower than the preferred value of about 10⁻⁷ torr.

An absolute gas pressure lower than atmospheric pressure is conventionally referred to as a vacuum, but almost all vacuums generated by man will inevitably contain some gas molecules. At the preferred pressure of about 10⁻⁷ torr, some 3.5×10⁹ molecules are present in each cubic centimeter of gas.

The number and composition of these molecules are important features of this invention. It may be advantageous to use, in the gas dielectric capacitor, one or more gasses other than nitrogen. Hydrogen or helium have lower atomic masses, so that the mass density of the dielectric 64 may be further reduced. Helium has the advantage of being monatomic. On the other hand, xenon has a high atomic mass so that the mass of the dielectric may be increased without decreasing the value of V at which arcing occurs. Optionally, sulfur hexafluoride, or SF₆, may be used to increase the voltage at which arcing occurs at the same pressure.

Other experimenters have had success using solid dielectrics 64, i.e., a solid dielectric capacitor. Ceramic, such as barium titanate, will store a large amount of energy per unit volume, thus increasing the available mass fluctuation. However, the material has a high value of the dielectric loss tangent, which can lead to excessive heat dissipation. Other solid dielectrics such as polytetrafluoroethylene (PTFE), polyester or synthetic film such as MYLAR® or the like have lower dielectric losses so that the applied power may be increased without causing heating problems.

FIG. 3b shows the magnetic analog of the vacuum capacitor shown in FIG. 3a. The magnetic analog comprises a coil 66 wound around a magnetic material 65. The coil 66 is driven by a time varying current source 167. The stored energy is created by the magnetic field induced in the magnetic material 65 by the coil 66. The time varying nature of the stored energy provides the value of

$$\frac{{\partial }^{2} E}{\partial {t}^{2}}$$

in equation (5). The magnetic material 65 preferably consists of a vacuum of about 10⁻⁷ torr of a paramagnetic gas such as oxygen. Atmospheric air may also be used, and the pressure may be set anywhere between 10⁻⁷ torr and atmospheric pressure because high voltage arc over is no longer a concern. A ferrite material may also be used for the magnetic material 65, giving a much higher energy storage density but at the expense of much higher mass density ρ₀. Magnetic material 65 may be homogeneous, i.e., only a single material, or a mixture of two or more magnetic materials or media.

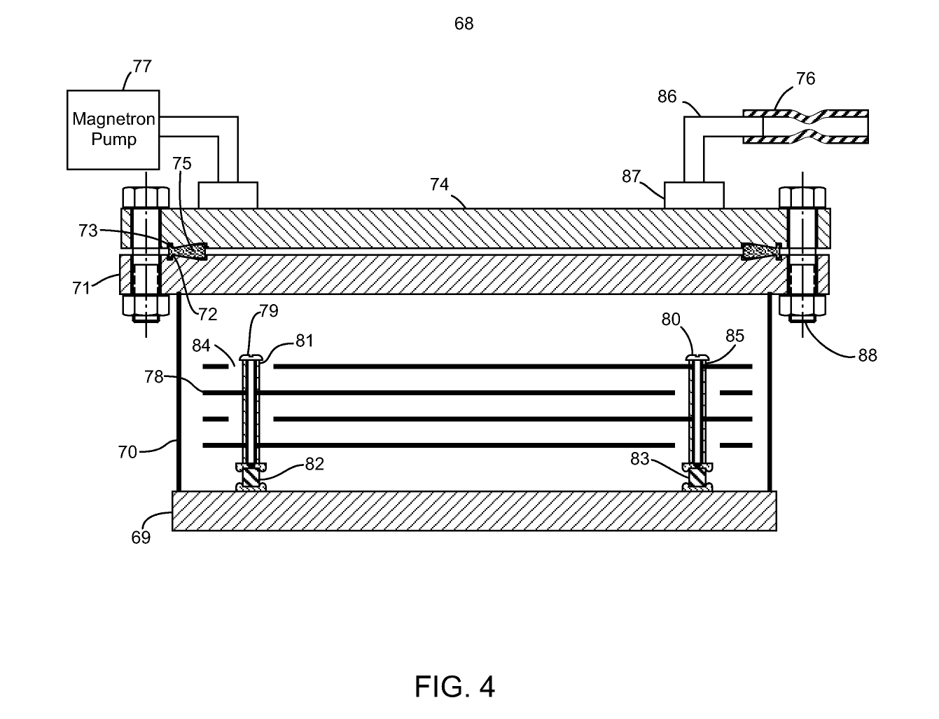

Fragility of the vacuum capacitor 8 is an important issue if it is to be spun on a rotating arm. It is not anticipated that the capacitor illustrated in FIG. 3a will be able to withstand much vibration, so FIG. 4 shows an improved vacuum capacitor which is considerably more robust and likely to be able to withstand vibrations. A robust vacuum capacitor 68 is housed in a vacuum chamber, preferably made partly or entirely of stainless steel. The chamber comprises a circular stainless steel base plate 69, welded to a stainless steel wall 70. A knife edge seal 72 is disposed around the edge of a flange 71, matching a similar knife edge seal 73 disposed around the edge of a top plate 74 and secured with bolts or the like 88. A copper gasket 75 of about 0.1 inch thickness seals the top plate 74 to the bottom plate 71. Such an sealing arrangement is well known in the art of ultra-high vacuums, and is commercially available as a CONFLAT® seal, a registered trademark of Varian, Inc. of Palo Alto, Calif.

A KOVAR® tube 86 is attached to the top plate 74 by means of a CONFLAT® seal 87, to which a glass tube 76 has been attached. The glass of glass tube 76 is selected to have the same or substantially the same coefficient of thermal expansion as the material of tube 86, whether KOVAR® or another material, while also preferably being impervious to helium diffusion. This tube 86 is for the purpose of evacuating the chamber.

For initial pump down, the glass tube 76 is attached to a suitable vacuum system, and the entire chamber is baked preferably at about 400 degrees Celsius for a few hours. A sample of the desired operating gas is then introduced via the same glass tube 76, after which the tube 76 is fused shut using, for example, a flame.

Once the entire system has been cooled to room temperature, a magnetron pump 77 is turned on. The current flowing through magnetron pump 77 is a good indicator of the level of vacuum inside the chamber, and the pump 77 is allowed to run until the vacuum has reached the desired level.

During routine maintenance of the plant, the pump 77 may also be briefly run to check the vacuum level. If the chamber pressure is not sufficiently low, then the pump 77 is allowed to run for a period until the chamber pressure is back in specification. If the pressure is too low, or the chamber springs a leak or otherwise requires maintenance, then the assembly 86, 76 and 87 is simply replaced so that a new vacuum may be pumped into the chamber.

Advantages of the glass tube 76 are that it eliminates the need for a ultra-high vacuum shutoff valve, which does not tolerate vibration or dust very well, and is prone to leakage in the long term. It is also much lighter and cheaper than an ultra-high vacuum shutoff valve.

For pressures below about 10⁻⁹ torr, the magnetron pump 77 may be operated continuously, both during operation of the plant and during standby periods. While a loss of power to the magnetron pump 77 of a few hours is tolerable, longer outages may damage the vacuum level permanently, requiring a re-bake of the chamber.

The capacitor itself in the vacuum chamber comprises a stack of copper plates 78, held in place by a retaining structure such as machine screws 79 and 80. While four plates 78 and two screws 79, 80 are shown for clarity, it is to be understood that a multiplicity of plates 78 and screws 79, 80 may be used, as well as alternative plate-retaining structure. The more screws 79, 80 that are used, the less vibration will be experienced by the plates 78 and the more robust the assembly will be.

Spacers 81 maintain the parallel alignment of the plates 78, and ceramic standoff insulators 82 and 83 insulate the plates from the chamber. High alumina ceramic is preferably used for the material of the insulators 82, 83 to avoid contamination of the vacuum. High voltage feedthroughs (not shown) are used to connect the plates 78 to structure outside of the chamber.

Holes 84 are formed in the plates 78 and sized to leave an appropriate clearance from capacitor plate 78 to spacer 81, while the diameter of holes 85 is approximately equal to the internal diameter of the spacers 81. The clearance from hole 84 to spacer 81 is preferably slightly larger than the spacing between the plates 78, to avoid high voltage arcing.

The complete apparatus is shown schematically in FIG. 5. A DC electric motor/generator 9 drives a rotatable or rotating arm 10 on which the variable mass vacuum capacitor 8 (C1) is mounted. A rotation shaft leading from the motor/generator 9 is connected to an approximate center region of the rotating arm 10. A counterweight 19 balances the rotating arm 10. An electronic switch 12 connects the generator 9 either to a charged capacitor 13 (C2) or a load 14. Rotating arm 10 may be elongate with the mass vacuum capacitor 8 at one end and the counterweight 19 on the opposite end. Rotating arm 10 may also have a non-elongate form. The variable mass vacuum capacitor 8 and counterweight 19 are on the same side of the rotating arm 10, wherein the motor/generator 9 is on an opposite side of the rotating arm 10. Support structure for the motor/generator 8 and to retain the rotating arm 10 while allowing its rotation, is provided, but not shown.

During most of the rotational cycle of the rotating arm 10, the generator 9 is connected to the capacitor 13 to charge the capacitor 13. During the low mass part of the cycle, power flows from the capacitor 13 to the motor (now acting as a motor rather than as a generator) 9, speeding up the rotating arm 10. During a portion of the high mass part of the cycle, power flows from the generator 9 back to the capacitor 13, recharging it. Once the generator 9 has slowed to the appropriate speed, the switch 12 is activated and the remaining power from the generator 9 is switched to the load 14. Thus, the rotor arm 10 rotates at a substantially constant speed, with small fluctuations at about 6 Hz as the capacitor 13 charges and discharges. For a part of this cycle, useful power may be transferred to the load 14.

The variable mass vacuum capacitor 8 is powered from a high resolution (preferably 16 bit) arbitrary waveform generator 15 which, in a preferred embodiment, is programmed to provide a rounded sawtooth waveform at a frequency of about 6 Hz. This output frequency signal is filtered through a low pass filter 16 to remove any step waveforms, then amplified by a high voltage amplifier 17 to an amplitude of, for example, 20 kilovolts.

Electrical leads or wires connect the high voltage amplifier 17 to the variable mass vacuum capacitor 8 via slip rings 18, where the electric voltage produces a fluctuating electric field leading, in turn, to transient fluctuations of mass, i.e., in combination constituting a mass fluctuation producing system, alternatively referred to as a mass fluctuation producer or production mechanism.

The arbitrary waveform generator 15 also controls the electronic switch 12 such that the generator 9, now acting as a motor, is driven by capacitor 13 during the lighter mass part of the rotational cycle of the rotating arm 10. During the heavier mass part of the cycle, the generator 9 recharges the capacitor 13. Once the capacitor 13 has been fully recharged, the electronic switch 12 is set to deliver the remaining power to the load 14. The high voltage amplifier 17 may optionally be located on the rotating arm 10 so as to avoid the need for high voltage slip rings 18 with the attendant corona discharge losses.

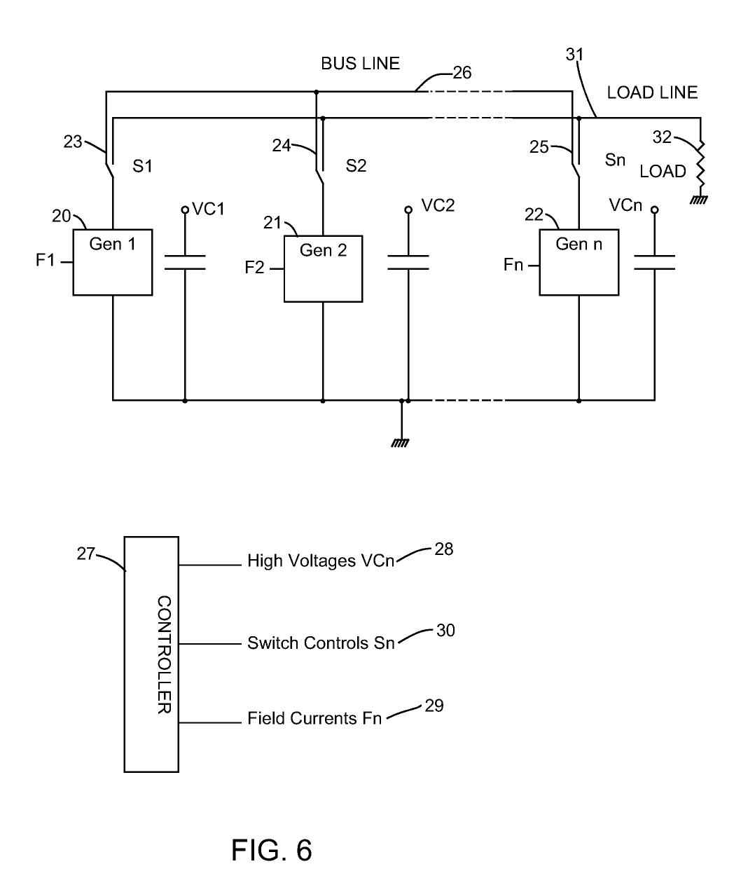

For power generation installations producing more than a few kilowatts, the value of C2, capacitance of capacitor 13, will be impractically large. In this case, a number of generator units can be operated together as shown in FIG. 6. The operating principle for this embodiment is that the flywheel effect of some generators is used as energy storage for others, in place of the capacitance provided by capacitor 13.

As shown in FIG. 6, a plurality of generators 20, 21 and 22 are connected to a common ground, and the output of each generator 20, 21, 22 is switched via a respective electronic switch 23, 24, and 25 to a common bus line. A controller 27 provides the high voltage rounded sawtooth waveform VCn 28 to each variable mass vacuum capacitor, as well as field currents Fn 29 for the generators 20, 21, 22 and switch control signals Sn 30 for the electronic switches 23, 24, 25. Controller 27 thus serves as a control system for controlling the mass fluctuations of the variable mass vacuum capacitor.

For most of the rotational cycle of the rotating arm 10, each generator 20, 21, 22 is connected via its electronic switch 23, 24, 25 to the bus line 26. During the light part of the cycle of each generator 20, 21, 22, it receives power from one or more of the other generators, and accelerates. During a portion of the heavy part of the cycle of each generator 20, 21, 22, it sends power to one or more of the other generators, and during the remainder of the heavy part of the cycle, the switch 23, 24 or 25 sends any excess power to the load line 31 leading to the load 32. The control signals to the generators 20, 21, 22 are preferably phased so that the pulses of current are delivered to the load 32 in an evenly spaced manner.

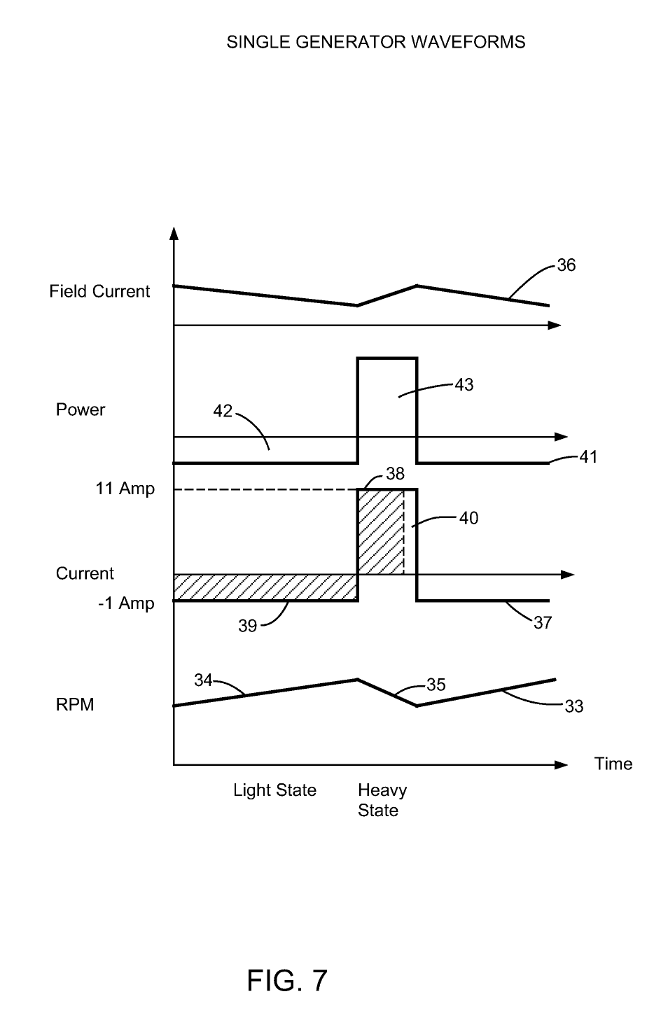

The various waveforms are shown for a single generator over a single cycle in FIG. 7. The time axis shows a single cycle of the preferably 6 Hz waveforms. The rate of rotation of the generator is designated 33. While the variable mass vacuum capacitor is in its light state, the RPM of the shaft increases, shown at 34. While in its heavy state, shown at 35, the RPM is decreasing. In view of the increased mass, the total energy released along RPM line portion 35 exceeds the energy absorbed at RPM line portion 34. In spite of the fluctuating shaft speed, the output voltage is held constant by changing the field current 36 to the generator. At lower RPM, an increased field current is used to hold the output voltage constant. This field current is supplied by the controller 27.

The generator output current waveform is shown at 37. During the light part of the cycle, the generator is taking current (i.e., acting as a motor) and increasing the speed of the variable mass vacuum capacitor. During the heavy part of the cycle, the generator is providing current to one or more of the other motor/generators as shown at line portion 38. The shaded area of line portion 38 is equal to the shaded area 39, showing that the energy removed from the variable mass vacuum capacitor during slowdown is equal to that supplied during speed up. The surplus energy 40 is used to provide the various losses (such as copper loss, iron loss, and windage), in addition to the output power delivered to the load. More energy is provided during line portions 38 and 40 than consumed during current line portion 39, because the mass of the variable mass vacuum capacitor is greater during slow down than it is during speed up.

A power waveform 41 is similar to the current waveform, since the voltage is constant. Negative values 42 of the power waveform 41 mean that power is consumed during the light state (motor mode) and positive values 43 of the power waveform 41 mean that power is supplied to the other generators, the various losses, and the load.

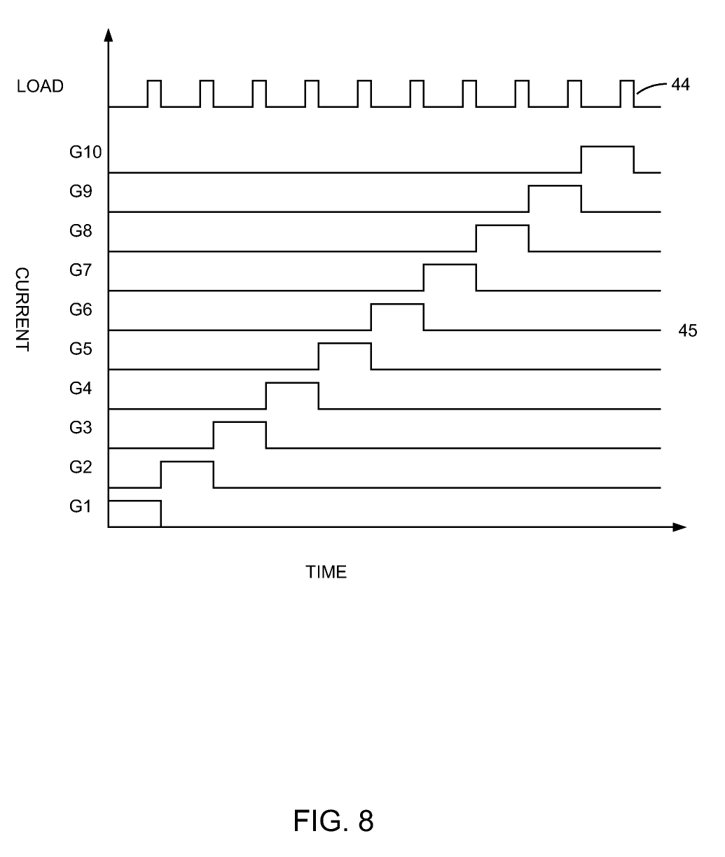

In an embodiment wherein ten generators are provided, the timing diagram for all of the generators together is shown in FIG. 8. The controller 27 staggers the operation of the ten generators so that the output current into the load 32 consists of regularly spaced current pulses. The current 45 in each generator is shown as G1 to G10 in FIG. 8. It is to be understood that while 10 is an exemplary number of generators, any number of generators can be used depending on the timing ratio of the light state to the heavy state of operation. Through experimentation, a ratio of 10:1 works well, but other ratios are certainly possible and contemplated to be within the scope and spirit of the invention.

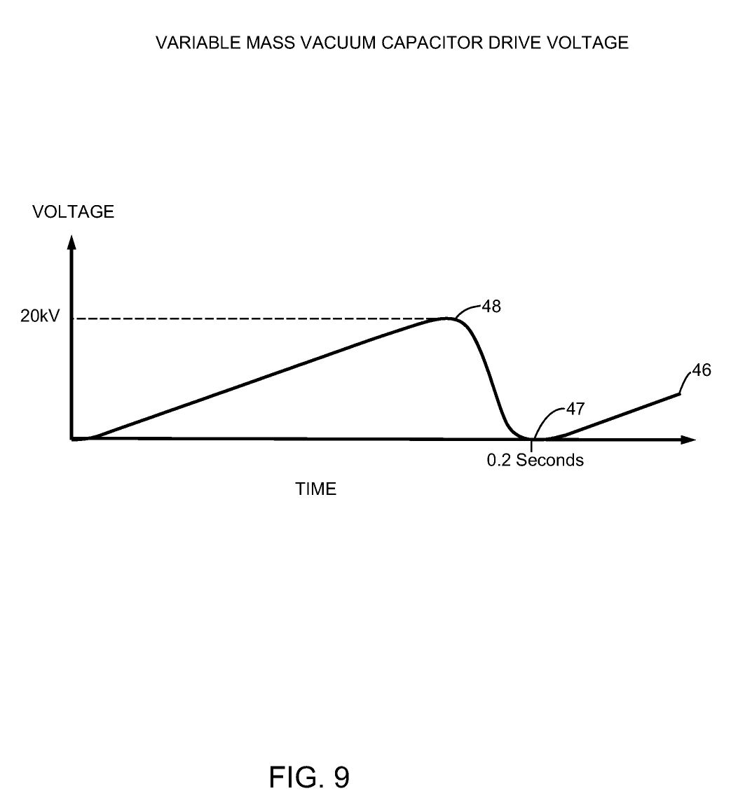

FIG. 9 shows a drive waveform 46 for the variable mass vacuum capacitor unit. Since the load of this unit is purely capacitive, no power (apart from the losses) is consumed by the capacitors. Most of the losses involved are in the high voltage power supply itself. Commercially available high voltage supplies generally run at efficiencies of around 80%, which is more than adequate for the purposes of the invention. As stated above, it is important that the waveform be smooth and free from any steps, so that a high resolution digital waveform generator is required, preferably at least 16 bit and storing at least 32 k voltage samples. Smooth transitions 47 and 48 are generated by a suitable computer algorithm (for example, a spline curve) at switch on, then stored in a memory of the controller 27 ready for sampling, or alternatively stored in a memory component accessible or available to the controller 27.

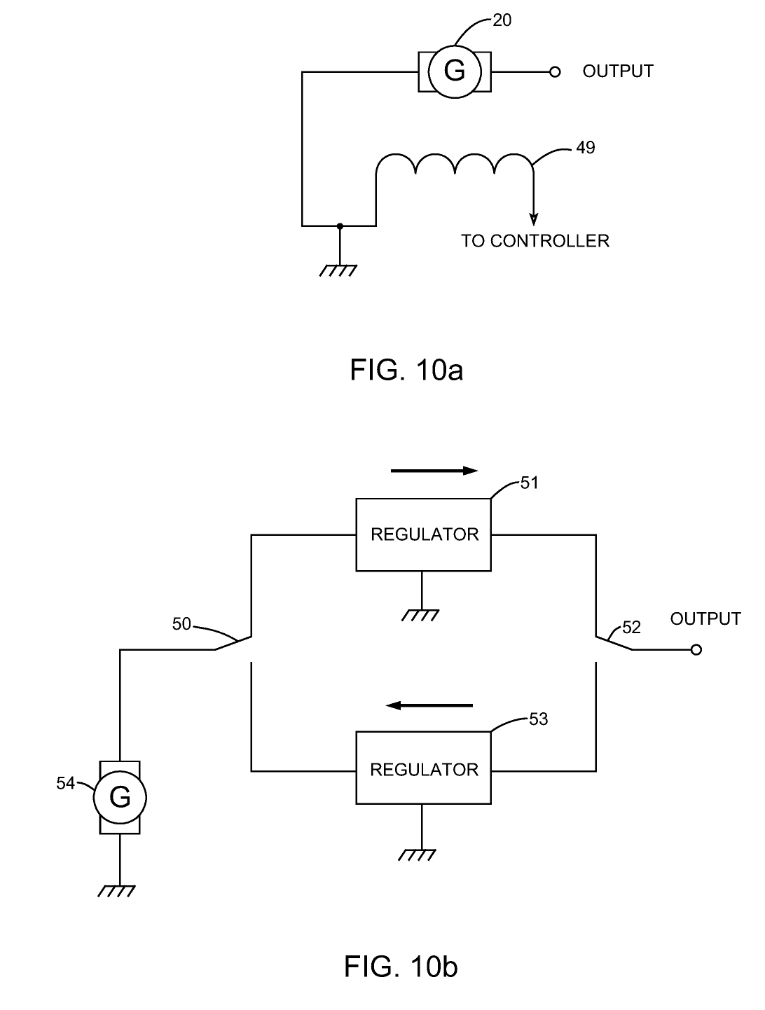

For larger installations, it may be impractical to drive the field current for the generators at a suitably high frequency, since this would cause unacceptable iron and copper loss. FIG. 10b shows an alternative embodiment, better suited to large installations. FIG. 10a shows the embodiment described above wherein the generator 20 is connected to output. The output voltage is controlled by the current through field coils 49, which are driven by the controller 27. The controller 27 adjusts the field current such that the output voltage remains constant in spite of speed fluctuations of the generator 20.

FIG. 10b shows the alternative embodiment wherein output of a generator 54 varies with changes in the speed of the generator shaft. When operating in generator mode, voltage is directed via an electronic switch 50 to a regulator 51, which is preferably a high efficiency switched mode voltage regulator. The constant output voltage from regulator 51 is directed to the output via an electronic switch 52.

When the generator 54 operates in its motor mode, the drive voltage is fed via the electronic switch 52 to the input of a regulator 53. The constant voltage output of regulator 53 is then fed via the electronic switch 50 to the generator 54, now acting as a motor. The electronic switches 50 and 52 are controlled by the controller 27 so as to run in motor mode while on the light phase of the cycle, and generator mode on the heavy phase of the cycle.

At times, one of the embodiments shown in FIG. 10a or 10b would be better suited for the situation. The choice of which embodiment shown in FIGS. 10a and 10b is to be implemented may be made based upon the relative efficiencies of the switched mode regulators 51 and 53 versus the shunt wound generator 20, while being switched at the preferred frequency of about 6 Hz. This choice will, of course, depend upon the state of the art of switched mode voltage regulators, but in general, the embodiment of FIG. 10b is likely to be preferred for larger installations.

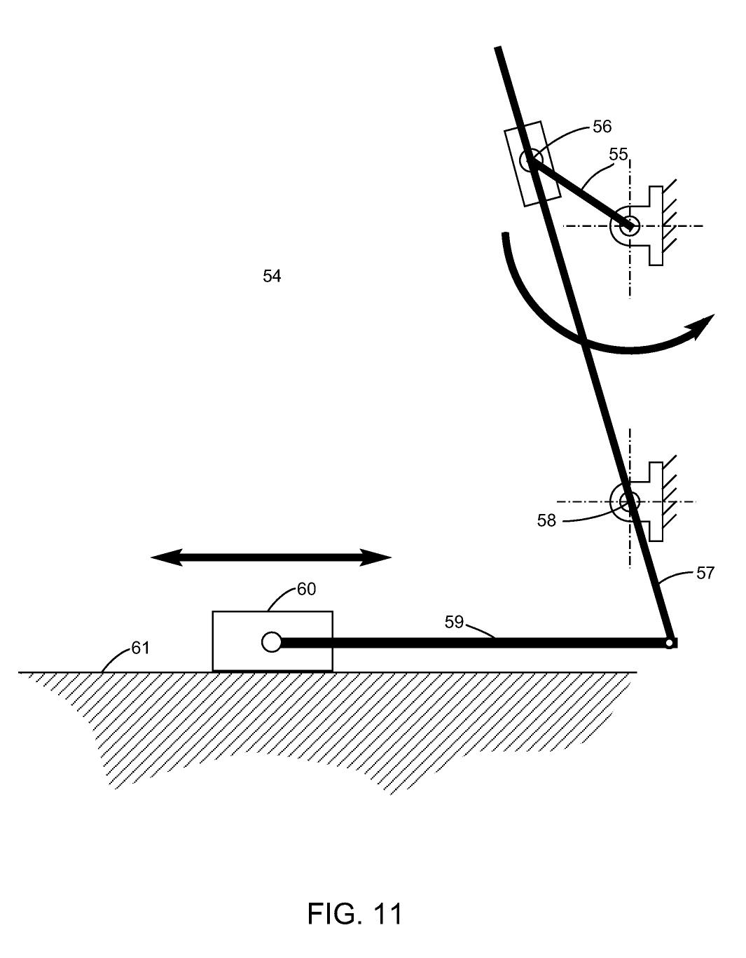

The variable mass vacuum capacitor described above has other applications in addition to the generation of power. For example, by using a linear actuator rather than the motor/generator set described, the variable mass vacuum capacitor can be pushed while light and pulled when heavy, generating a net thrust for either space-based or terrestrial use. This is illustrated in FIG. 11. A Whitworth quick return mechanism 54, which is well known in the art, comprises an arm 55 which is driven by a motor (not shown) at constant speed. A slider slides along an arm 57, which is pivoted at 58. A connecting rod 59 connects to the variable mass vacuum capacitor 60, which is constrained to run on rails 61.

It will be appreciated by those familiar with the art that the variable mass vacuum capacitor 60 will be driven to the right at a lower speed than it will be driven to the left. The same high voltage sawtooth as described above is applied to the vacuum capacitor 60 (connecting wires not shown). The arm 55 rotates at the same frequency as the high voltage sawtooth so that the mass of the variable mass vacuum capacitor 60 is greater when moving to the left than it is while moving to the right. Since the connecting rod 59 pulls a heavy mass but pushes a light mass, a net thrust is produced to the right. It is important to realize that the different speeds to the left and to the right do not in any way contribute to the production of thrust. The reason for the different speeds in different directions is because the high voltage sawtooth has to be asymmetrical in order to cause mass fluctuations. Therefore, more time is available for movement in one direction than in the other. Thrust production is purely a consequence of the mass fluctuations, and is not related to the different speed in different directions.

By Newton's third law, the net thrust (or action) must have an equal and opposite reaction. As explained in the Woodward patent, this reactive thrust comes from celestial objects so that Newton's Third Law and also the law of conservation of momentum hold true. An advantage of this invention is that, because the reactive force comes from celestial objects, it does not need to come from the atmosphere as would be the case for, say, an aircraft propeller. So the thruster in FIG. 11 is useful anytime that thrust is required, but backwash is undesirable.

As also explained in the Woodward patent, it is also a “propellantless” way of generating thrust in a spacecraft, similar to solar sails. Since no mass is ejected from the spacecraft, it is not necessary to carry large amounts of mass on board (such as fuel and oxidizer) provided that an alternative source of energy, for example nuclear energy, is available.

As stated above, the present invention differs from the teachings of Woodward in that radically different dielectric densities and frequencies of operation are used, and also the value of δm is much greater than that of m, a condition not covered or contemplated by Woodward's design equations.

Many attempts have been made to operate a variable mass unit with a high voltage ceramic capacitor, typically at a frequency of several tens of kilohertz. While these units clearly do produce mass fluctuations, they have not been suitable for power generation because of the high frequencies involved and the high density of the dielectric. Most of these attempts (described in the Woodward patent, among others) have been designed to utilize the variable mass in order to produce thrust for space travel, rather than to generate power for terrestrial use.

A key improvement of the present invention is thus the use of low frequency, high voltage and ultra-low density dielectric. By using vacuum capacitors, the density of the dielectric is determined by the level of vacuum used, about 10⁻⁷ torr for the vacuum capacitors described. This corresponds to a density of roughly 1.7×10⁻¹⁰ kg/m³, compared with about 3,000 kg/m³ disclosed in the Woodward patent. Since ρ₀ is in the denominator of equation (5), this represents an improvement in potential mass change of approximately 1.8×10¹² times. This improvement comes at the expense of being unable to calculate the exact value of δm, because it exceeds the rest mass of the vacuum m so that the equations identified in the Woodward patent are no longer believed to be applicable. However, useful values of δm/m have been observed experimentally, and the equations identified by the Woodward patent will likely be extended to meet these new conditions in the fullness of time.

It will be readily apparent to those skilled in the art that it is possible to mount a plurality of variable mass vacuum capacitors on a rotating disc rather than a rotating arm, to mitigate problems of vibration and to avoid the necessity of swinging “dead weight”, which increases the start-up time of the plant.

A power plant in accordance with the invention can be built to any desired scale. Small plants of a kilowatt or so can be used to provide power at remote locations, unconstrained by the availability of sunlight, wind, or oceans and operating 24 hours per day. Larger plants of a few megawatts can be used to power small communities without the need for expensive and lossy power transmission lines running over hundreds of miles. Plants on the scale of hundreds or thousands of megawatts can be used for base load supply to the grid. The startup time for a plant is mainly determined by the time and energy requirements to get the rotor up to speed. Therefore, it would even be possible to use such a plant for peak demand on the grid to a limited extent. Since there is no fundamental limit on the size of a vacuum capacitor, this component can be scaled to generate the amount of power appropriate for any given situation.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

I claim:

1. A system for extracting energy from celestial objects based on the scalar gravitational potential of the celestial objects, comprising:
a rotatable arm;
a mass fluctuation producing system arranged on said arm and comprising dielectric material whose mass fluctuates between a relatively light mass and a relatively heavy mass when subjected to a changing electromagnetic field in view of the scalar gravitational potential of the celestial objects;
a rotation system that rotates said arm at a variable speed to cause rotation of said mass fluctuation producing system thereon; and
a control system coupled to said mass fluctuation producing system and said rotation system and configured to control said mass fluctuation producing system and said rotation system in order to accelerate the dielectric material when it has a relatively light mass and decelerate the dielectric material when it has a relatively heavy mass,
whereby excess energy arising from an energy differential between the acceleration and deceleration of the dielectric material is directed to a load.

2. The system of claim 1, wherein said mass fluctuation producing system comprises a variable mass vacuum dielectric capacitor mounted on said arm.

3. The system of claim 2, wherein said vacuum dielectric capacitor comprises nitrogen at about 10⁻⁷ Torr, wherein said control system comprises a waveform generator that provides the electromagnetic field to said vacuum dielectric capacitor, said waveform generator being configured to provide a periodic sawtooth waveform with rounded corners.

4. The system of claim 1, wherein said mass fluctuation producing system comprises a gas dielectric capacitor at a pressure between about 760 Torr and 10⁻¹¹ Torr and containing at least one of air, hydrogen, helium, xenon, and sulfur hexafluoride, wherein said control system comprises a waveform generator that provides the electromagnetic field to said gas dielectric capacitor, said waveform generator being configured to provide a periodic sawtooth waveform with rounded corners.

5. The system of claim 1, wherein said mass fluctuation producing system comprises a solid dielectric capacitor including ceramic, polytetrafluoroethylene, polyester or synthetic film, wherein said control system comprises a waveform generator that provides the electromagnetic field to said solid dielectric capacitor, said waveform generator being configured to provide a periodic sawtooth waveform with rounded corners.

6. The system of claim 1, wherein said mass fluctuation producing system comprises a vacuum chamber or a ferromagnetic substance arranged within a fluctuating magnetic field.

7. The system of claim 1, wherein said rotation system comprises at least one motor/generator.

8. The system of claim 7, wherein said at least one motor/generator is configured to use a varying field current to feed power in a desired direction.

9. The system of claim 1, wherein said rotation system comprises a plurality of motor/generators.

10. The system of claim 9, wherein said control system controls said motor/generators to cause excess power to be transferred from one of said motor/generators to at least one other of said motor/generators.

11. The system of claim 1, further comprising a switch that connects said rotation system alternatively to a capacitor or to the load.

12. The system of claim 11, wherein said control system comprises a waveform generator that provides the electromagnetic field to said mass fluctuation producer, said waveform generator controlling said switch based on the output waveform such that said rotation system serves as a motor driven by said capacitor during a relatively lighter mass part of a rotation of said arm and serves as a generator during a relatively heavier mass part of the rotation to recharge said capacitor, whereby after said capacitor has been charged, said switch delivers power to the load.

13. The system of claim 12, wherein said waveform generator is configured to output a rounded sawtooth waveform at a frequency of about 6 Hz, said power supply system further comprising a low pass filter configured to remove any step waveforms and an amplifier configured to amplify the output of said waveform generator.

14. A method for extracting energy from celestial objects based on the scalar gravitational potential of the celestial objects, comprising:
subjecting dielectric material situated on a rotatable arm to a changing electromagnetic field to cause the mass of the dielectric material to fluctuate between a relatively light mass and a relatively heavy mass in view of the scalar gravitational potential of the celestial objects; and controlling the electromagnetic field to which the dielectric material is subjected and rotational force provided to the arm in order to accelerate the dielectric material when it has a relatively light mass and decelerate the dielectric material when it has a relatively heavy mass,
whereby excess energy arising from an energy differential between the acceleration and deceleration of the dielectric material is directed to a load.

15. The method of claim 14, wherein the step of controlling the electromagnetic field to which the dielectric material is subjected and rotational force provided to the arm comprises outputting a periodic sawtooth waveform with rounded corners from a waveform generator and directing a derivative of the output waveform to a circuit including the dielectric material.

16. The method of claim 14, wherein the step of controlling the electromagnetic field to which the dielectric material is subjected and rotational force provided to the arm comprises coupling at least one motor/generator to the arm, and connecting the at least one motor/generator in a circuit with a capacitor and the load.

17. The method of claim 16, wherein the step of controlling the electromagnetic field to which the dielectric material is subjected and rotational force provided to the arm further comprises connecting a switch in the circuit, the switch having a first position including the load in the circuit and a second position including the capacitor in the circuit.

18. The method of claim 17, wherein the step of controlling the electromagnetic field to which the dielectric material is subjected and rotational force provided to the arm further comprises outputting a periodic sawtooth waveform with rounded corners from a waveform generator and directing a derivative of the output waveform to a circuit including the dielectric material.

19. The method of claim 18, wherein the step of controlling the electromagnetic field to which the dielectric material is subjected and rotational force provided to the arm further comprises controlling the switch via the waveform generator based on the output waveform such that the at least one motor/generator serves as a motor driven by the capacitor during a relatively lighter mass part of a rotation of the arm and serves as a generator during a relatively heavier mass part of the rotation to recharge the capacitor, whereby after the capacitor has been charged, the switch delivers power to the load.

20. The method of claim 14, wherein the step of controlling the electromagnetic field to which the dielectric material is subjected and rotational force provided to the arm comprises coupling a plurality of motor/generators to the arm, and controlling the motor/generators to cause excess power to be transferred from one of the motor/generators to at least one other of the motor/generators.
